(19) United States
(12) Patent Application Publication
(10) Pub. No.: US 2005/0137268 A1
(43) Pub. Date: Jun. 23, 2005

(54) Silica sol and process for preparing the same

(76) Inventors: Taewan Kim, Seoul (KR); Jihoon Rhee, Seongnam-si (KR); Daechul Park, Suwon-si (KR)

Correspondence Address: David A. Einhom, Esq.;Anderson Kill & Olick, P.C., 1251 Avenue of the Americas, New York, NY, 10020, US

(21) Appl. No.: 11/022,221

(22) Filed: Dec. 23, 2004

(30) Foreign Application Priority Data
Dec. 23, 2003 (KR) 10-2003-0095792

(51) Int. Cl. C01B 33/141

(52) U.S. Cl. 516/81

(57) ABSTRACT

A silica sol prepared by a specified method and present in the form of a dispersion in a specific hydrophobic organic solvent exhibits an excellent dispersion-stability and contains the silica particles having a minimal amount of adsorbed residual organic materials.

### FIELD OF THE INVENTION

The present invention relates to a silica sol dispersed in a hydrophobic organic solvent possessing an excellent dispersion-stability, and a method for preparing the same.

### BACKGROUND OF THE INVENTION

Silica sol is used in the preparation of an organic insulating film used in a semiconductor device to improve the physical properties of the film. However a conventional silica sol has poor dispersion-stability because silica particles tend to agglomerate in a solution due to the interaction of the hydroxyl groups existing on the surfaces thereof.

Accordingly, there have been numerous attempts to increase the dispersion-stability of a silica sol by using a hydrophilic solvent and additives such as acids, bases and salts (Japanese Patent Application Publication Nos. 1993-97422; 1993-85717; 1994-199515; 1997-67114; and 1997-208213), or conducting a surface modification of silica sol particles (Japanese Patent Application Publication Nos. 1999-43319; 1982-196717; 1983-145614 and 1991-187913; and U.S. Pat. Nos. 6,025,455; 5,651,921 and 2,801,185). However, the silica sol prepared using additives or surface modifiers exhibits an irregular distribution of the secondary particle size (agglomerated particles having a particle size ranging from 300 nm to several μm); and the residual organic materials or metal ions originating from added acids, bases, salts or surface modifiers cause defect formation or poorly reproducible dielectric constant of the organic insulating film.

Accordingly, the present inventors have endeavored to develop a silica sol that is free from the above problem, and have found that a silica sol prepared by a specified method in the form of a dispersion in a specific hydrophobic organic solvent exhibits an excellent dispersion-stability and contains a minimal amount of residual organic materials.

### SUMMARY OF THE INVENTION

Accordingly, it is a primary object of the present invention to provide a method for preparing a silica sol that exhibits an excellent dispersion-stability, without additives and surface modifiers which have been used in the conventional silica sols.

It is another object of the present invention to provide a silica sol having an excellent dispersion-stability and containing the minimal amount of residual organic materials or metal ions.

In accordance with one aspect of the present invention, there is provided A method for preparing a silica sol dispersed in a hydrophobic organic solvent, which comprises the steps of (i) mixing a silica sol dispersed in an alcohol with a hydrophobic organic solvent in the absence of an additive or a surface modifier; and (ii) removing the alcohol from the mixture obtained in step (i) by evaporation.

In accordance with another aspect of the present invention, there is provided a silica sol dispersed in a hydrophobic organic solvent having average particle sizes of primary-particles and secondary-particles in the ranges of 5 to 15 nm and 70 to 100 nm, respectively.

### BRIEF DESCRIPTION OF THE DRAWINGS

The above and other objects and features of the present invention will become apparent from the following description of the invention, when taken in conjunction with the accompanying drawings, which respectively show:

FIG. 1: A schematic view showing that silica sol microparticles interact with the hydrophobic organic solvent to form a complex, and heat treating the bound complex gives a primary particle;

FIG. 2: Scanning electron microscopy (SEM) image of the primary particles of the inventive silica sol prepared in Example 1;

FIG. 3: Size distribution of the secondary particles of the inventive silica sol prepared in Example 1;

FIGS. 4A and 4B: Time-dependent changes in the viscosity (4A) and passage test parameters (4B) of the inventive silica sol prepared in Example 1.

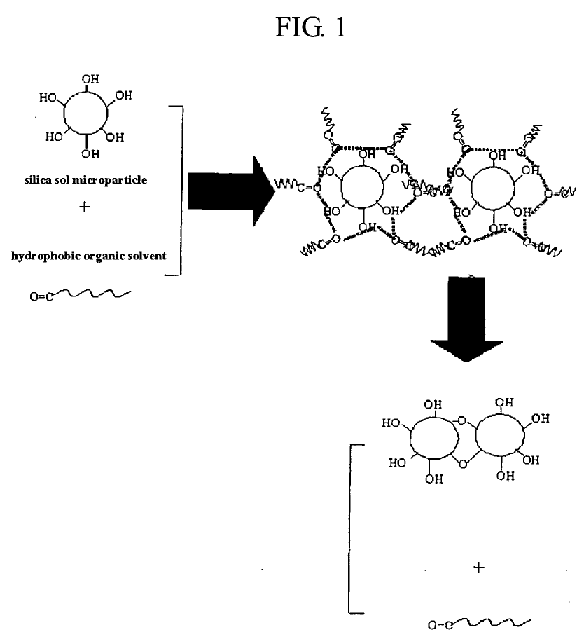

### DETAILED DESCRIPTION OF THE INVENTION

The term “primary-particle” herein means an individual particle or grain, and the term “secondary-particle” herein means agglomerated primary particles which act as a single particle.

The silica sol dispersed in an alcohol comprises silica particles having an average particle size ranging from 5 to 20 nm, preferably from 10 to 15 nm, and the alcohol may be methanol, ethanol, propanol, isopropanol, t-butanol or n-butanol, preferably methanol or ethanol.

The hydrophobic organic solvent used in the inventive method may have one or more carbonyl groups (C═O) which can form a strong hydrogen bond with hydroxyl groups, a carbon number of 5 to 20 and a boiling point of 100 to 200° C., and representative examples thereof include propyleneglycol monomethylether acetate (PGMEA), methylisobutylketone (MIBK), diethylketone, methylpropylketone, ethylpropylketone, dipropylketone, butylethylketone, methylisoamylketone, butylisopropylketone, and a mixture thereof.

The hydrophobic organic solvent may be employed in step (i) in an amount ranging from 1 to 100 folds by weight based on the weight of the silica sol dispersed in an alcohol.

Steps (i) and (ii) may be conducted at a temperature ranging from −10 to 100° C., and step (ii) may be repeated one to five times under a nitrogen atmosphere.

The inventive method may further comprises conventional steps of wet-grinding and filtering the silica sol dispersed before step (i) or after step (ii). The step of grinding may be conducted at a temperature ranging from −10 to 100° C. using a wet grinding equipment, and the step of filtering may be carried out using a 0.2 μm filter.

The silica sol dispersed in a hydrophobic organic solvent, which is prepared by the inventive method, comprises primary-particles having an average particle size of 5 to 15 nm and secondary-particles having an average particle size of 70 to 100 nm. The hydrophobic organic solvent has one or more carbonyl groups, a carbon number of 5 to 20 and a boiling point of 100 to 200° C., and D₅₀ and D₉₀ of the secondary-particle range from 30 to 500 and 100 nm to 1 μm, respectively.

The inventive silica sol may be prepared without using any additive, such as an acid (e.g., HX wherein X is halogen, sulfide, nitride or chloride, and organic acid containing COOH); a base (e.g., MOH wherein M is alkali metal, alkaline earth metal or RₙNHₘ (wherein n is 1, 2, 3 or 4 and m is 0, 1, 2 or 3)); or a salt (e.g., MX wherein M is alkali metal, alkaline earth metal, transition metal or RₙNHₘ (wherein n is 1, 2, 3 or 4 and m is 0, 1, 2 or 3), and X is halogen, sulfide, nitride or Iodide)). The inventive method also employs no surface modifier which can modify OH groups on the surfaces of silica sol particles.

The inventive silica sol exhibits a uniform particle size distribution and an excellent dispersion-stability, and consequently, it does not lead to agglomeration of the silica particles for an extended period of time. Also, the inventive silica sol contains only a minimal amount (less than 2% by weight) of residual organic materials, i.e., all organic materials (containing water) except silica particles and hydrophobic organic solvent, adsorbed on the silica particles, while the metal content thereof is practically nil, less than 10 ppm. Therefore, the inventive silica sol may be beneficially used in the process of insulating film fabrication, Braun tube coating, eyeglass lens coating or anti-glare coating to improve their physical properties without generating defects in a highly reproducible manner.

The following Examples are given for the purpose of illustration only and are not intended to limit the scope of the invention.

### EXAMPLE 1

### Preparation of Silica Sol Dispersed in Hydrophobic Organic Solvent

A silica sol dispersed in isopropyl alcohol (IPA) (solid content: 30% by weight) having an average particle size of 5 to 20 nm was treated with an ion exchange resin to remove residual metal cations. 200 ml of the silica sol thus obtained was ground with a wet grinding equipment at 0° C. for 10 min, and filtered through a 0.2 μm syringe filter. The filtered silica sol (solid content: 29.5% by weight) was placed in a low-temperature vacuum evaporator which had previously been nitrogen-purged, 200 ml of-20° C. PGMEA was added thereto, and the mixture was stirred slowly (below 100 rpm) at 0° C. for 3 hours. The resulting silica sol (solid content: 29.5% by weight) was wet-ground at 0° C. for 10 min, and filtered through a 0.2 μm syringe filter to obtain a desired silica sol (solid content: 29% by weight).

The particle size, and the residual IPA and metal ion contents of the resulting silica sol were analyzed with a particle size analyzer (PSA), gas chromatography-mass spectrometer (GC-MS) and inductively coupled plasma-mass spectrometer (ICP-MS), and the results were:
average primary-particle size: 5 to 10 nm;
average secondary-particle size: 90.8 nm;
residual IPA content: 1.06% by weight; and
residual metal ion content: below 10 ppm.

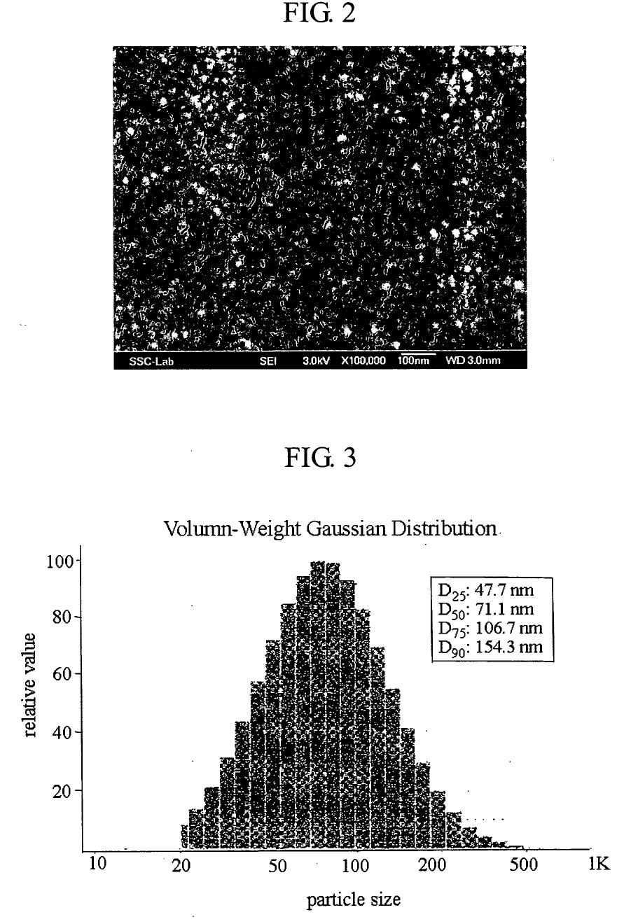

The primary-particle SEM image and secondary-particle size distribution of the silica sol prepared in Example 1 are shown in FIGS. 2 and 3, respectively, which show that the inventive silica sol has a uniform particle size distribution: the average size ranges from 70 to 100 nm; D₂₅ is 47.7; D₅₀ is 71.1; D₇₅ is 106.7; and D₉₀ is 154.3.

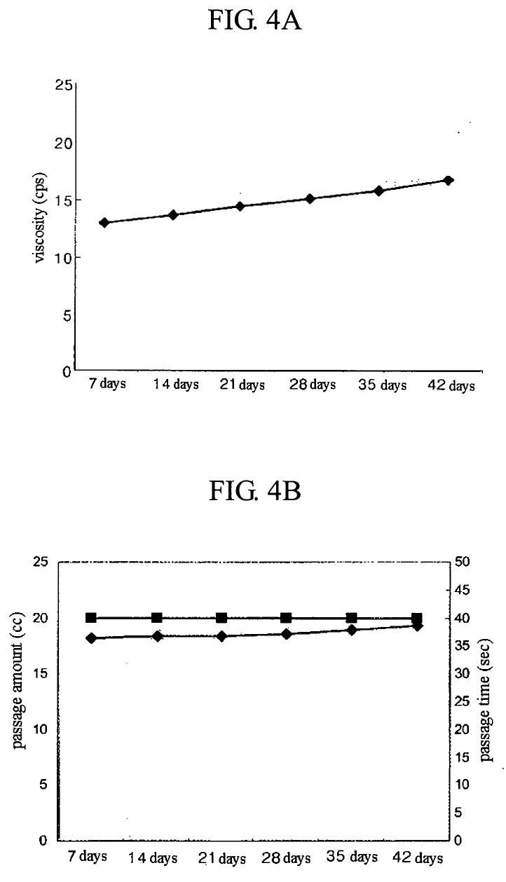

Further, the time-dependent change in the viscosity of the silica sol prepared in Example 1 was analyzed with a viscometer (DV-E 230, Brook Field) at 5° C., and the result is shown in FIG. 4A. According to FIG. 4A, it can be seen that the viscosity of the inventive silica sol increases only slightly (from 13 to 17 cps).

Also, the silica sol prepared in Example 1 was passed through a 0.2 μm syringe filter using a nitrogen pressure of 0.1 MPa, and the results in terms of the passage amount as function of time are shown in FIG. 4B. As shown in FIG. 4B, the amount of passed silica sol was constant over 42 day period, and therefore it can be seen that the dispersion stability of the inventive silica sol is excellent.

### EXAMPLE 2

### Preparation of Silica Sol Dispersed in Hydrophobic Organic Solvent

The procedure of Example 1 was repeated except for using MIBK instead of PGMEA to obtain a desired silica sol (solid content: 29% by weight). The particle size, and the residual IPA and metal ion contents of the resulting silica sol were analyzed, and the results were:
average primary-particle size: about 10 nm;
average secondary-particle size: 95 nm;
residual IPA content: 1.09% by weight; and
residual metallic ion content: below 13 ppm.

### EXAMPLE 3

### Preparation of Insulating Film Using the Inventive Silica Sol

MSQ-based siloxane polymer, the silica sol obtained in Example 1, or heptakis[2,3,6-tri-O-methoxy]-β-cyclodextrin as a pore generating material (porogen) were added to PGMEA according to Table I to obtain coating solutions 1 to 4, wherein the solid (siloxane polymer+solid of silica sol) content was adjusted to 26% by weight based on the weight of the resulting coating solutions, and the content of the pore generating material was adjusted to 30% by weight based on the solid content.

TABLE I

| Coating | Siloxane | Solid content | | PGMEA |
|---|---|---|---|---|
| Solution No. | polymer (g) | of silica sol (g) | Porogen (g) | (g) |
| 1 | 2.6 | 0 | 0 | 7.4 |
| 2 | 2.457 | 0.143 | 0 | 6.38 |
| 3 | 2.6 | 0 | 0.78 | 7.4 |
| 4 | 2.457 | 0.143 | 0.78 | 6.38 |

Silicon wafers were spin-coated using coating solutions 1 to 4 for 30 sec at 3000 rpm, respectively, and dried over at 150° C. for 1 min and 250° C. for 1 min on a hot plate under a nitrogen atmosphere to obtain films. The resulting films were baked at 400° C. for 1 hour with heating rate of 3° C./min to obtain four insulating films. The thickness, refractive index, dielectric constant, hardness, modulus of elasticity and surface roughness with atomic force microscope (AFM) of the resulting insulating films were analyzed, and the results are shown in Table II.

TABLE II

| Coating | Refrac- | Thick- | | Hard- | Modulus of | Surface |
|---|---|---|---|---|---|---|
| Solution | tive | ness | Dielectric | ness | Elasticity | roughness |
| No. | Index | (Å) | constant | (GPa) | (GPa) | (nm) |
| 1 | 1.4144 | 8344 | 2.70 | 1.101 | 5.741 | 0.7038 |
| 2 | 1.4134 | 8811 | 2.79 | 1.207 | 6.274 | 1.2840 |
| 3 | 1.3331 | 7049 | 2.24 | 0.483 | 3.072 | 0.4408 |
| 4 | 1.3413 | 7127 | 2.35 | 0.723 | 4.616 | 1.0520 |

As can be seen from Table II, the physical properties of the insulating films obtained using the inventive silica sol (coating solutions 2 and 4) are much superior to those of coating solutions 1 and 3.

While the invention has been described with respect to the above specific embodiments, it should be recognized that various modifications and changes may be made to the invention by those skilled in the art which also fall within the scope of the invention as defined by the appended claims.

1. A method for preparing a silica sol dispersed in a hydrophobic organic solvent, which comprises the steps of (i) mixing a silica sol dispersed in an alcohol with a hydrophobic organic solvent in the absence of an additive or a surface modifier; and (ii) removing the alcohol from the mixture obtained in step (i) by evaporation.

2. The method of claim 1, wherein the silica sol dispersed in an alcohol has an average particle size ranging from 5 to 20 nm.

3. The method of claim 2, wherein the alcohol is selected from the group consisting of methanol, ethanol, propanol, isopropanol, t-butanol and n-butanol.

4. The method of claim 1, wherein the hydrophobic organic solvent has at one or more carbonyl groups (C═O), a carbon number of 5 to 20 and a boiling point of 100 to 200° C.

5. The method of claim 4, wherein the hydrophobic organic solvent is selected from the group consisting of propyleneglycol monomethylether acetate (PGMEA), methylisobutylketone (MIBK), diethylketone, methylpropylketone, ethylpropylketone, dipropylketone, butylethylketone, methylisoamylketone, butylisopropylketone, and a mixture thereof.

6. The method of claim 1, wherein the hydrophobic organic solvent is employed in an amount ranging from 1 to 100 folds by weight based on the weight of the silica sol dispersed in an alcohol.

7. The method of claim 1, wherein step (ii) is repeated one to five times.

8. The method of claim 1, which further comprises the steps of wet grinding and filtering the silica sol before step (i) or after step (ii).

9. The method of claim 1, wherein all steps comprised are conducted at a temperature ranging from −10 to 100° C.

10. A silica sol dispersed in a hydrophobic organic solvent having average particle sizes of primary-particles and secondary-particles in the ranges of 5 to 15 nm and 70 to 100 nm, respectively.

11. The silica sol of claim 10, wherein D₅₀ and D₉₀ of the secondary-particles range 30 to 500 nm and 100 nm to 1 μm, respectively.

12. The silica sol of claim 10, wherein the hydrophobic organic solvent has one or more carbonyl groups, a carbon number of 5 to 20 and a boiling point of 100 to 200° C.

13. The silica sol of claim 12, wherein the hydrophobic organic solvent is selected from the group consisting of propyleneglycol monomethylether acetate (PGMEA), methylisobutylketone (MIBK), diethylketone, methylpropylketone, ethylpropylketone, dipropylketone, butylethylketone, methylisoamylketone, butylisopropylketone, and a mixture thereof.
